(19) United States
(12) Patent Application Publication
(10) Pub. No.: US 2026/0141723 A1
(43) Pub. Date: May 21, 2026

(54) SYSTEM AND METHOD FOR EVALUATING ENVIRONMENTS

(71) Applicant: Rivers Agile, Callery, PA (US)

(72) Inventors: Benjamin Wilson, Pittsburgh, PA (US); Mark Alan Westerland, JR., Pittsburgh, PA (US); James Thomas Tallon, Bethel Park, PA (US)

(21) Appl. No.: 19/393,972

(22) Filed: Nov. 19, 2025

Related U.S. Application Data
(60) Provisional application No. 63/722,311, filed on Nov. 19, 2024.

(51) Int. Cl. G06V 20/52; G06V 10/75

(52) U.S. Cl. CPC G06V 20/52; G06V 10/751

(57) ABSTRACT

Methods and systems for managing workplace task compliance is disclosed. The method includes, receiving, by a computing device, a request from an operator, wherein the request includes a particular workplace task, providing a camera unit and a display device in an environment in which the particular workplace task is to be completed, capturing, by the camera unit, one or more images of the environment, utilizing a machine learning model configured to provide a safety compliance status of the environment, inputting a plurality of values from the captured images of the environment into the machine learning model, outputting values from the machine learning model to determine the safety compliance status of the environment, and alerting the operator of the determined safety compliance status of the environment.

### CROSS-REFERENCE TO RELATED APPLICATION

This application claims priority benefit of U.S. Provisional Application No. 63/722,311 filed Nov. 19, 2024, entitled SYSTEM AND METHOD FOR EVALUATING USER EXPERIENCE, the content of which is hereby incorporated by reference in its entirety.

### FIELD

The present disclosure relates to an innovative management solution that utilizes various factors of an environment to optimize compliance with safety protocols and increase overall business efficiency.

### BACKGROUND

In high-risk environments such as manufacturing facilities, for example, safety protocols are set forth for several tasks. Failure to strictly comply with safety protocols in workplace settings can expose an organization to significant legal and financial consequences, such as increased insurance premiums, greater workers'compensation costs, and/or elevated deductibles. Organizations typically rely on detailed checklists and scheduled inspections that a designated operator must complete to demonstrate compliance with various safety protocols. For reasons, such as the repetitive nature of the job, this process is inherently vulnerable to human error. Items can be overlooked, steps can be skipped, and/or documentation can be completed inaccurately.

Implementing the processes described herein, organizations can significantly reduce these risks, driving greater consistency and reliability in their safety programs. In turn, this increased efficiency has the potential to lower incident rates and reduce overall operational and risk management costs. By systematically capturing, analyzing, and responding to real-time environmental data, the disclosed systems and methods reduce reliance on manual safety checks, minimize human error, and streamline workflows, thereby improving both regulatory compliance and operational performance across a wide range of industrial and commercial settings.

Moreover, collecting and analyzing environmental factors allows organizations to improve consumer interaction with their offered goods and/or services. For example, the discussed system and methods create an opportunity for organizations to acquire and analyze unique human behavioral data related to a test user experiencing an environment.

### SUMMARY

The present disclosure may include a system, apparatus, and/or method that may have one or more of the following features and/or steps, which alone and/or in combination may include patentable subject matter.

According to a first aspect of the present disclosure, a method is disclosed. The method includes receiving, by a computing device, a request from an operator, wherein the request includes a task parameter, providing a camera unit and a display device in a desired environment and capturing, by the camera unit, one or more images of the desired environment. The method further includes utilizing a machine learning model configured to provide a status of the desired environment, inputting a plurality of values from the captured images of the desired environment into the machine learning model, outputting values from the machine learning model to determine the status of the desired environment, and alerting the operator of the determined status of the desired environment.

According to a second aspect of the present disclosure, a method is disclosed. The method includes receiving, by a computing device, a request from an operator, wherein the request includes a particular workplace task, providing a camera unit and a display device in an environment in which the particular workplace task is to be completed, and capturing, by the camera unit, one or more images of the environment. The method further includes utilizing a machine learning model configured to provide a safety compliance status of the environment, inputting a plurality of values from the captured images of the environment into the machine learning model, outputting values from the machine learning model to determine the safety compliance status of the environment, and alerting the operator of the determined safety compliance status of the environment.

A machine readable medium including a plurality of instructions is also disclosed. The instructions, in response to being executed, may result in a computing device creating a plan for an operator to bring an environment and/or piece of equipment in compliance with a particular safety protocol based at least in part on a request that includes images of a current state of the environment. The instructions may further result in the computing system transmitting the plan to an organization and/or a third party via a network.

### BRIEF DESCRIPTION OF THE DRAWINGS

The present disclosure is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 shows a system for generating plans that have been customized for a particular task and/or environment according to at least one aspect of the present disclosure.

FIG. 2 shows a computer assisted safety system of FIG. 1 according to at least one aspect of the present disclosure.

FIG. 3 shows more details regarding the computer assisted safety system of FIG. 2 according to at least one aspect of the present disclosure.

FIG. 4 shows a representation of a method of managing workplace procedure compliance with the computer assisted safety system according to at least one aspect of the present disclosure.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM), random access memory (RAM), magnetic disk storage media, optical storage media, flash memory devices, and others.

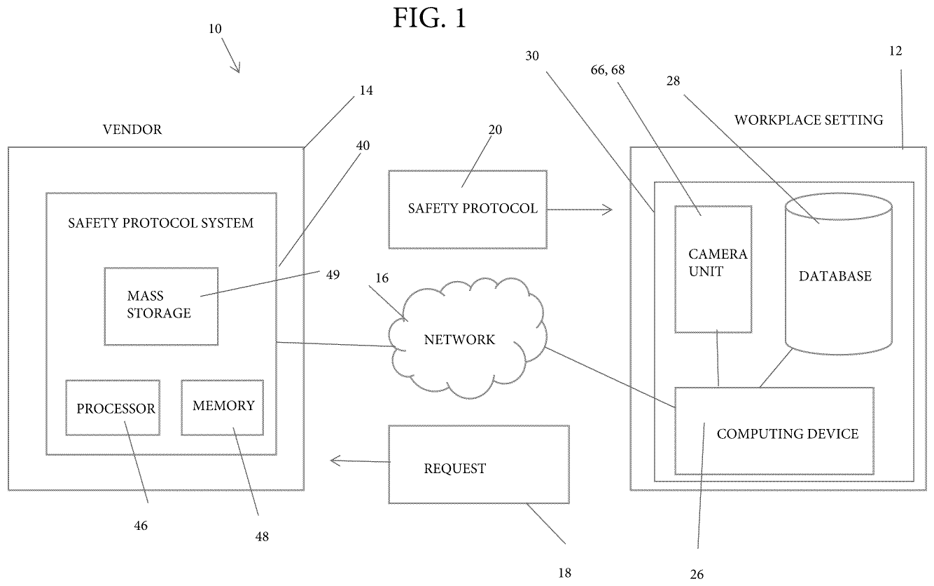

Referring to FIG. 1, a system 10 that customizes and executes safety protocols is shown. The system 10 may include a vendor 14 that provides a custom safety protocol 20. In particular, the vendor 14 may provide custom safety protocols 20 in the form of digital checklists associated with a particular task and/or environment. An organization's successful completion of the provided digital checklists ensures compliance with the pertinent safety protocols for each particular task and/or environment as safety concerns vary across industries, tasks, and/or environments.

The system 10 may further include a workplace setting 12 in which a particular task is to be completed within a particular environment and a network 16 that communicatively couples the vendor 14 and the workplace setting 12. In various instances, the workplace setting 12 includes a production facility, a manufacturing warehouse, and/or an outdoor workplace, such as an oil rig, for example.

The network 16 may include one or more wide area networks (WAN), local area networks (LAN), and/or publicly-accessible global networks such as, for example, the Internet. In addition, the network 16 may include one or more wired networks and/or wireless networks. As such, the network 16 may include routers, switches, computers, communication links, and/or other networking components that cooperate to operatively couple the vendor 14 and the workplace setting 12.

The workplace setting 12 may include one or more computing devices or clients 26, databases 28, and one or more camera units such as, for example, mobile camera unit 66 and/or a fixed camera unit 68. The one or more computing devices 26 may display data and receive input from user(s) at the workplace setting 12. The one or more computing devices 26 may include a variety of different computing devices such as, for example, servers, desktop computers, laptop computers, handheld computers, personal data assistants, mobile phones, and/or any other suitable computing devices. A computing device 26 is illustrated in FIG. 1 as being physically located within the workplace setting 12; however, in some instances, one or more of the computing devices 26 may remotely access the workplace setting network from location(s) external to the workplace setting 12. Such instances may enable user(s) to order and/or otherwise define custom safety protocols 20 while the user is away from the workplace setting 12.

In at least one instance, the workplace setting 12 may include both types of camera units 66, 68. In some instances, other peripherals, such as display screens, lights, and the like may be coupled, or otherwise may be used in conjunction with, one or more of the camera units 66, 68.

The mobile camera unit 66 includes a chassis, an image capture assembly, and a control module. The chassis defines a housing that supports various electrical components of the mobile camera unit 66 therein. In various instances, the chassis includes an attachment mechanism that allows the mobile camera unit 66 to be mounted, or otherwise attached, to a desired fixture, such as a body of a user or a stand, for example. The image capture assembly includes at least one camera configured to capture still images and/or video. In at least one instance, the image capture assembly is configured to capture images to create a 3D representation of a particular landscape. The control module is communicably coupled to the image capture assembly and the computing device 26 such that the control module is configured to receive control signals from a remote user and/or transmit, or otherwise communicate, the captured images and/or videos to the computing device 26. The control module may communicate by way of one or more wireless transceivers (e.g., Wi-Fi, cellular, or Bluetooth) and/or a wired interface (e.g., Ethernet, USB). In use, the mobile camera unit 66 provides enhanced flexibility and coverage within a desired environment. For example, the mobile camera unit 66 can be deployed to a target environment and maneuvered to one or more positions within the target environment while capturing image and/or video data. Because the mobile camera unit 66 is not constrained to a fixed mounting location, it can be repositioned to capture multiple landscapes, or view points, from within the same overall area, thereby increasing the amount and/or diversity of visual data collected during a given monitoring session. The mobility is further advantageous in environments where mounting locations are limited or unavailable, such as open fields or large indoor spaces without suitable walls or other mounting structures, for example.

The fixed camera unit 68 similarly includes a chassis, an image capture assembly and a control module. The fixed camera unit 68 operates similarly to the mobile camera unit 66 described above and is communicatively coupled to the computing device 26. The fixed camera unit 68 can be fixedly mounted, or otherwise secured, to a single location within a target environment to continuously capture a particular landscape. For example, the fixed camera unit 68 can be mounted to a ceiling or a wall of a workplace setting 12. Such a fixed position can provide several operational benefits. Because the fixed camera unit 68 remains in a known, repeatable position, it can be used to capture the same landscape, or field of view, every time, which facilitates consistent image comparison over time and improves system reliability. This repeatability can reduce variability caused by operator placement and can enhance the accuracy of baseline image sets and/or trend analysis, for example.

The vendor 14 may include a safety plan system 40. The safety plan system 40 may receive a request 18 to provide a safety protocol via network 16 from the workplace setting 12, generate a safety protocol 20 that has been customized based upon information of the received request, and provide the workplace setting 12 with the custom safety protocol 20 via network 16. The safety plan system 40 may include a microprocessor, microcontroller, discrete processing circuitry (e.g., a collection of logic devices), general purpose integrated circuit(s), and/or application specific integrated circuit(s) (i.e., ASICs). A memory device 48 may include volatile memory devices such as, for example, dynamic random access memory (DRAM) and static random access memory (SRAM). The memory device 48 may further include non-volatile memory devices such as, for example, various types of read-only memory (i.e., ROM) and FLASH memory devices. The memory devices 48 generally store data and/or instructions that the processors 46 are currently processing and/or expected to process in the near future.

In addition to the above-mentioned components, the safety plan system 40 may include other devices and/or circuitry typically found in computing devices such as, for example, displays, input/output devices, and/or other peripheral components.

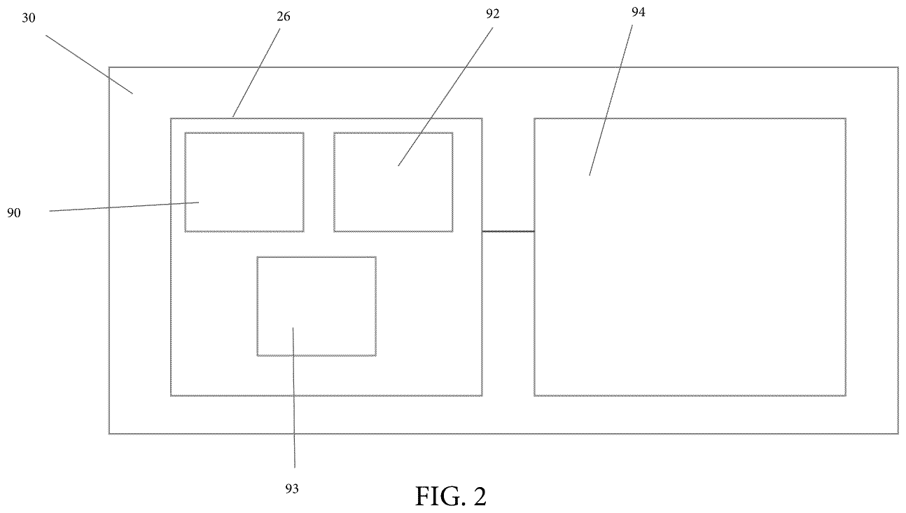

Referring now to FIG. 2, additional details of the computer assisted safety system 30 are depicted. In particular, the computing device 26 may include a processor 90, a memory device 92, and mass storage device 93. The processor 90 may include a microprocessor, a microcontroller, discrete processing circuity (e.g., a collection of logic devices), general purpose integrated circuit(s), and/or application specific integrated circuit(s) (i.e., ASICs). The memory device 92 may include volatile memory devices such as, for example, dynamic random access memory (DRAM) and static random access memory (SRAM). The memory device 92 may further include non-volatile memory devices such as, for example, various types of read-only memory (i.e., ROM) and FLASH memory devices. The memory devoices 92 generally store data and/or instructions that the processors 90 are currently processing and/or expected to process in the near future.

The mass storage devices 93 may include hard drives, DVD drives, CD drives, database servers, and/or other devices suitable for storing large amounts of data and/or instructions. The mass storage devices 93 in at least one instance may store data and instructions in a non-volatile manner; however, other instances are envisioned that include mass storage devices such as large disk caches that store data and/or instructions in a volatile manner. The mass storage devices generally store data and/or instructions that the processor 90 is not expected to process in the near future and/or is desirable to retain for extended periods of time.

The computing device 26 is communicatively coupled with a display device 94. Although illustrated in FIG. 2 as separate from the computing device 26, in at least one instance, the display device 94 may form a portion of the computing device 26. Alternatively, the display device 94 and/or an additional display device may be positioned away from the computing device 26. The computing device 26 may include input devices such as a keyboard and/or a mouse for providing data input to the computing device 26. In various instances, the display device 94 may include a touchscreen display device capable of receiving inputs from a user. That is, the user may provide input data to the computing device 26, such as making a selection from a number of displayed choices, by simply touching the screen of the display device 94.

The computing device 26, database 28, and/or one or more camera units 66, 68 may assist an operator to safely complete various tasks including, for example, adequately and readily positioning safety features throughout a particular environment. The computing device 26 is designed to detect a presence or an absence of one or more relevant objects within a desired environment. To do so, the one or more camera units 66, 68 may be positioned such that the field of view of the camera units 66, 68 covers a desired environment in which the desired task is to be completed.

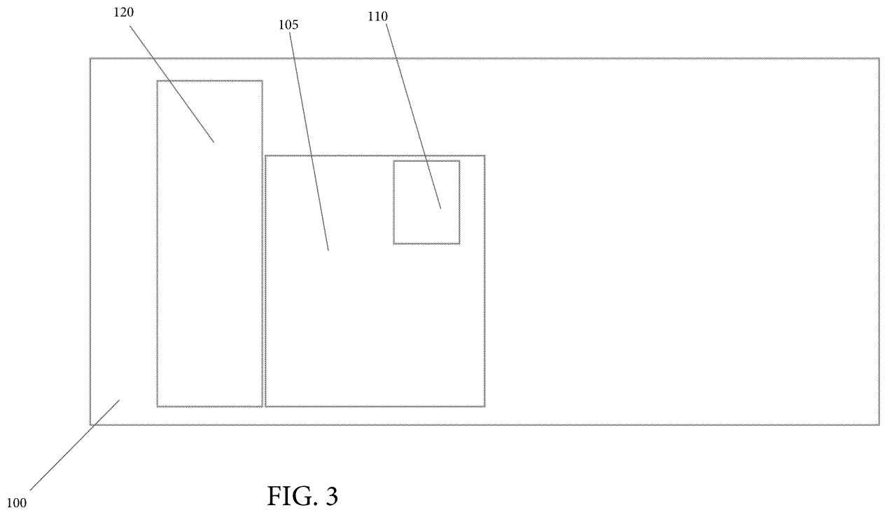

For example, as illustrated in FIG. 3, an exemplary desired environment is a production facility 100 having one or more pieces of equipment, such as a scissor jack 105, operationally positioned therein. A customized safety protocol may specify that one or more safety features 110, such as a fire extinguisher, for example, be readily accessible to an operator and/or user of the scissor jack 105 within the production facility. The computer assisted safety system 30, using the one or more camera units 66, 68, captures, or otherwise monitors, the desired environment in three dimensions to generate corresponding spatial data. The processing unit analyzes the spatial data to detect and locate one or more safety features, compare their respective positions to predefined thresholds defined in the safety protocol 20, and determine whether the safety protocol is satisfied. In instances where the processing unit detects a deficiency in operational safety as defined by the safety protocol 20, the computer assisted safety system 30 is configured to generate an alert to communicate to a user by way of a notification, for example. The computer assisted safety system 30 may further store the occurrence in a database for communication to management and/or a designated third party, such as an insurance company, for example.

In various instances, the computer assisted safety system 30 is further designed to detect an orientation, or specific position, of one or more pieces of equipment within the desired environment to identify potential malfunctions and/or hazards, for example. In such instances, the computer assisted safety system 30 may generate three-dimensional representations of the scissor jack 105 and one or more of its components. The computer assisted safety system 30 may then compare the detected positions and/or orientations of such components to expected positional relationships defined by the safety protocol 20. If one or more components of the scissor jack 105 are determined to be in an unintended position relative to one another, such as an over-extended linkage, a misaligned platform, or an improperly seated base, for example, the computer assisted safety system 30 can determine that an equipment malfunction or hazardous condition exists and issue an alert to a user.

In various instances, the computer assisted safety system 30 may determine that the scissor jack 105 is positioned too close to another piece of equipment 120 or structural feature within the desired environment, thereby presenting a risk of collision or equipment malfunction during operation. The computer assisted safety system 30 can then generate a warning signal and/or a recommended corrective action, such as repositioning the scissor jack 105 or adjusting an operating path, for example, to mitigate the potential hazard.

The computer assisted safety system 30 can alert an operator, an organization, and/or a third party regarding compliance with the safety protocol 20 in any suitable manner. For example, the computer assisted safety system 30 can generate a report that is communicated to an organization to summarize an operator's compliance with a safety protocol. The computer assisted safety system 30 can further communicate alerts in real-time to an operator notifying them of the specific instances of non-compliance with the safety protocol. Such real-time feedback can allow an operator to cease operations until the environment is brought into compliance, for example. The computer assisted safety system 30 can further communicate recommendations for how to rectify the non-compliance. For example, if a particular piece of equipment was missing from the environment, the computer assisted safety system 30 could suggest where to purchase the piece of equipment and/or suggest where to locate the equipment within the workplace setting 12, similar to an inventory manager.

Not only can the computer assisted safety system 30 alert an organization regarding compliance with safety protocols, but the computer assisted safety system 30 can further provide valuable consumer insight by monitoring one or more actionable insights. Such actionable insights include, for example, eye focus, repeated events, recall, frequency, recency, and/or retention. Such actionable insights are tracked and analyzed by the computer assisted safety system 30 to determine user perception of a particular environment, good, and/or service.

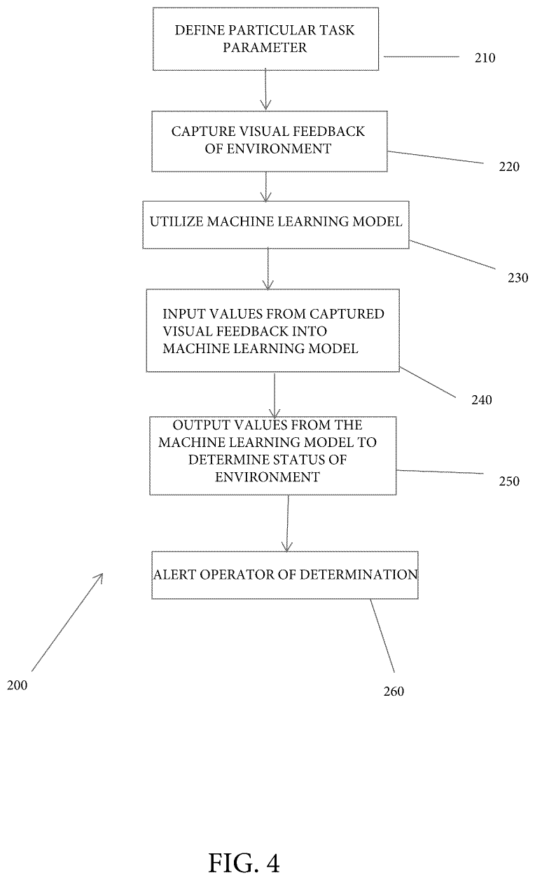

Referring now to FIG. 4, a process 200 is depicted for an operator to implement the disclosed methods and systems. At block 210, an operator in a workplace setting may define a particular task parameter for which the operator is seeking guidance. In various instances, the particular task parameter is a specific workplace task that the operator is seeking a customized checklist to ensure safety protocols are being complied with. In other instances, the particular task parameter is a general workplace environment that the operator is seeking a customized checklist to ensure safety protocols are being complied with and/or to collect user impressions.

At block 220, the system captures visual feedback of the environment defined by the identified particular task parameter and the provided safety protocol. At block 230, the operator utilizes a machine learning model to determine whether the equipment and/or surrounding environment within the workplace setting are in compliance with a particular safety protocol, and if not, how to remedy the non-compliance. At block 240, values from the captured visual feedback is inputted into the machine learning model, and at block 250 values corresponding to safety compliance are outputted from the machine learning model. At block 260, the machine learning model provides feedback to the operator regarding a status of safety compliance. Such feedback can be in the form of a report, an alert, and/or any other suitable communication to notify the operator of a workplace status.

What is claimed is:

1. A method, comprising:
receiving, by a computing device, a request from an operator, wherein the request includes a task parameter;
providing a camera unit and a display device in a desired environment;
capturing, by the camera unit, one or more images of the desired environment;
utilizing a machine learning model configured to provide a status of the desired environment;
inputting a plurality of values from the captured images of the desired environment into the machine learning model;
outputting values from the machine learning model to determine the status of the desired environment; and
alerting the operator of the determined status of the desired environment.

2. The method of claim 1, wherein the method further comprises the step of:
presenting, on the display device, a three-dimensional (3D) virtual environment to the operator.

3. The method of claim 1, wherein the task parameter includes a particular workplace task.

4. The method of claim 1, wherein the task parameter includes a particular workplace environment.

5. The method of claim 1, wherein the status of the desired environment includes a compliance value with a safety protocol.

6. The method of claim 5, wherein the compliance value corresponds to a specific violation of the safety protocol.

7. The method of claim 5, wherein the step of alerting the operator comprises:
communicating a violation of the safety protocol by identifying a violating condition.

8. The method of claim 5, wherein the step of alerting the operator comprises:
generating, by the computing device, a report including one or more compliance values associated with the safety protocol.

9. The method of claim 1, wherein the step of utilizing a machine learning model comprises:
retrieving, from a memory device, a digital template representing a setting compliant with a safety protocol associated with the workplace parameter, wherein the desired environment corresponds to the setting represented within the digital template.

10. The method of claim 9, wherein the step of utilizing the machine learning model further comprises:
comparing, by the computing device, the digital template to the inputted values from the captured images; and
determining, by the computing device, discrepancies between the digital template and the inputted values from the captured images.

11. The method of claim 1, wherein the step of capturing images of the desired environment includes capturing one or more reactions of the operator.

12. The method of claim 11, wherein the status of the desired environment includes a value of human sentiment.

13. A method, comprising:
receiving, by a computing device, a request from an operator, wherein the request includes a particular workplace task;
providing a camera unit and a display device in an environment in which the particular workplace task is to be completed;
capturing, by the camera unit, one or more images of the environment;
utilizing a machine learning model configured to provide a safety compliance status of the environment;
inputting a plurality of values from the captured images of the environment into the machine learning model;
outputting values from the machine learning model to determine the safety compliance status of the environment; and
alerting the operator of the determined safety compliance status of the environment.
